(19) United States
(12) Patent Application Publication
(10) Pub. No.: US 2025/0097852 A1
(43) Pub. Date: Mar. 20, 2025

(54) FILTER-BASED TIME-AVERAGED RADIO FREQUENCY EXPOSURE EVALUATION

(71) Applicant: QUALCOMM Incorporated, San Diego, CA (US)

(72) Inventors: Jagadish NADAKUDUTI, Bermuda Dunes, CA (US); Lin LU, San Diego, CA (US)

(21) Appl. No.: 18/471,235

(22) Filed: Sep. 20, 2023

(51) Int. Cl. H04W 52/22; H04W 52/36

(52) U.S. Cl. CPC H04W 52/225; H04W 52/36

(57) ABSTRACT

Certain aspects of the present disclosure provide techniques and apparatus for filter-based time-averaging radio frequency (RF) exposure evaluation. An example method of wireless communication includes determining an effective time-averaged transmit power associated with one or more past transmissions using a filter. The method further includes transmitting a signal in a time interval at a transmit power determined based at least in part on the effective time-averaged transmit power in compliance with an RF exposure limit.

### INTRODUCTION

### Field of the Disclosure

Aspects of the present disclosure relate to wireless communications, and more particularly, to radio frequency (RF) exposure compliance.

### DESCRIPTION OF RELATED ART

Wireless communication systems are widely deployed to provide various telecommunication services such as telephony, video, data, messaging, broadcasts, etc. Modern wireless communication devices (such as cellular telephones) are generally mandated to meet radio frequency (RF) exposure limits set by certain governments and international standards and regulations. To ensure compliance with the standards, such devices may undergo an extensive certification process prior to being shipped to market. To ensure that a wireless communication device complies with an RF exposure limit, techniques have been developed to enable the wireless communication device to assess RF exposure from the wireless communication device and adjust the transmit power of the wireless communication device accordingly to comply with the RF exposure limit.

### SUMMARY

Some aspects provide a method of wireless communication by a wireless device. The method includes determining an effective time-averaged transmit power associated with one or more past transmissions using a filter. The method further includes transmitting a signal in a time interval at a transmit power determined based at least in part on the effective time-averaged transmit power in compliance with a radio frequency (RF) exposure limit.

Some aspects provide an apparatus for wireless communication. The apparatus includes one or more memories collectively storing computer-executable instructions. The apparatus also includes one or more processors coupled to the one or more memories. The one or more processors are collectively configured to implement a filter and to execute the computer-executable instructions to cause the apparatus to perform an operation. The operation includes determining an effective time-averaged transmit power associated with one or more past transmissions using the filter. The operation also includes determining a transmit power based at least in part on the effective time-averaged transmit power in compliance with an RF exposure limit. The operation further includes transmitting a signal in a time interval at the determined transmit power.

Some aspects provide an apparatus for wireless communication. The apparatus includes means for determining an effective time-averaged transmit power associated with one or more past transmissions using a filter. The apparatus further includes means for transmitting a signal in a time interval at a transmit power determined based at least in part on the effective time-averaged transmit power in compliance with an RF exposure limit.

Some aspects provide a non-transitory computer-readable medium storing code that, when collectively executed by one or more processors of an apparatus, cause the apparatus to perform a method. The method includes determining an effective time-averaged transmit power associated with one or more past transmissions using a filter. The method further includes transmitting a signal in a time interval at a transmit power determined based at least in part on the effective time-averaged transmit power in compliance with an RF exposure limit.

Other aspects provide: an apparatus operable, configured, or otherwise adapted to perform any one or more of the aforementioned methods and/or those described elsewhere herein; a non-transitory, computer-readable medium comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example wireless communication system exhibiting radio frequency (RF) exposure to a human.

FIG. 2 is a block diagram conceptually illustrating a design of an example wireless communication device communicating with another device.

FIG. 3 is a graph illustrating examples of transmit powers over time in compliance with an RF exposure limit.

FIG. 4 is a flow diagram illustrating example operations for ensuring compliance with a time-averaged RF exposure limit using a filter that emulates a rolling time-averaging evaluation.

FIG. 5 is a flow diagram illustrating example operations for wireless communication by a wireless device.

FIG. 6 illustrates a communications device that may include various components configured to perform operations for the techniques disclosed herein.

To facilitate understanding, identical reference numerals have been used, where possible, to designate identical elements that are common to the figures. It is contemplated that elements disclosed in one aspect may be beneficially utilized in other aspects without specific recitation.

### DETAILED DESCRIPTION

Aspects of the present disclosure provide apparatus, methods, processing systems, and computer-readable mediums for evaluating time-averaged radio frequency (RF) exposure using a filter (e.g., an infinite impulse response (IIR) filter).

In certain cases, a regulatory agency (e.g., the Federal Communications Commission (FCC) for the United States) and/or a standards organization (e.g., the International Commission on Non-Ionizing Radiation Protection (ICNIRP)) may specify a time-averaged RF exposure limit in order to ensure safe levels of RF exposure as further described herein. A wireless communication device may evaluate the RF exposure over a time-averaging time window to determine a transmit power for a future time interval that is in compliance with the time-averaged RF exposure limit. To perform the time-averaging evaluation, the wireless device may track the transmit power history in a moving time window associated with the time-averaged RF exposure limit. The wireless device may store the transmit power history as transmit power(s) in a sequence of time intervals across the time window. Each time interval (e.g., 500 milliseconds (ms)) may have a corresponding transmit power level. For example, a wireless device may track the RF exposure history across 200 past exposure values in a 100-second time window.

Certain wireless devices (e.g., an Internet of things (IoT) device or a low-cost cellular phone) may lack the capability to store the transmit power history and/or perform the processing at a granularity of 500 milliseconds per time interval across an entire time-averaging time window, for example, due to the wireless device having a certain amount of memory (e.g., low memory for modem operations) and/or computational power for computational operations. Instead of time averaging, the wireless device may only allow transmit powers to be less than or equal to a maximum time-averaged transmit power (e.g., Pₗᵢₘᵢₜ) corresponding to the time-averaged RF exposure limit. In such cases, the wireless device may not be able to transmit above the maximum time-averaged transmit power regardless of the past transmission history associated with the wireless device. In some cases, the wireless device may run a time-averaging RF exposure evaluation using time intervals with longer durations (e.g., storing a transmit power every five seconds). Here too, the wireless device may operate at a lower peak power compared to a time-averaging evaluation using shorter time intervals. Therefore, such devices may transmit at reduced power levels compared to other devices, resulting in, for example, reduced throughput, higher latencies, and/or a reduced transmission range.

Aspects of the present disclosure provide apparatus and methods for evaluating time-averaged RF exposure using a filter. A wireless device may determine an effective time-averaged normalized RF exposure associated with past transmission(s) using the filter, such as an infinite impulse response filter, an integrating filter (e.g., a lossy integrator), or a recursive averaging filter. The filter may enable a time-averaging RF exposure evaluation that tracks the past transmission history associated with only a single time interval (e.g., 500 ms) in a time-averaging time window. For example, the filter may apply a variation of a recursive averaging filter using a scaling factor that estimates a time-averaging operation, as further described herein. Such a time-averaging RF exposure evaluation may allow certain wireless devices (e.g., devices with limited resources, such as IoT devices, low-memory devices, low-cost devices, etc.) to transmit in compliance with a time-averaged RF exposure limit and improve wireless communication performance.

The apparatus and methods for evaluating time-averaged RF exposure described herein may provide various advantages. For certain wireless devices (e.g., a low-memory device, IoT device, low-cost cellular phone, etc.), the apparatus and methods may improve wireless communication, including, for example, an increased throughput, decreased latency, and/or increased transmission range, where the improved performance may be attributable to using a filter that estimates a moving time-averaged window.

### Example RF Exposure Compliance

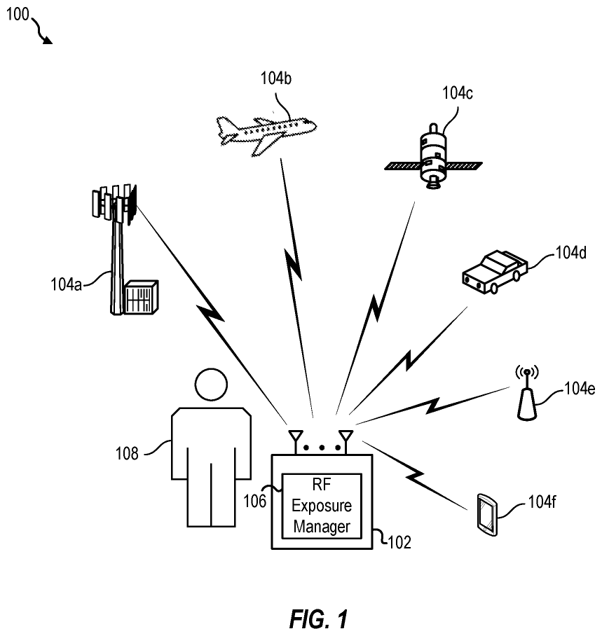

FIG. 1 illustrates an example wireless communication system 100 in which aspects of the present disclosure may be performed. For example, the wireless communication system 100 may include a wireless wide area network (WWAN) and/or a wireless local area network (WLAN). For example, a WWAN may include a New Radio (NR) system (e.g., a Fifth Generation (5G) NR network), an Evolved Universal Terrestrial Radio Access (E-UTRA) system (e.g., a Fourth Generation (4G) network), a Universal Mobile Telecommunications System (UMTS) (e.g., a Second Generation (2G) or Third Generation (3G) network), a code division multiple access (CDMA) system (e.g., a 2G/3G network), any future WWAN system, or any combination thereof. A WLAN may include a wireless network configured for communications according to an Institute of Electrical and Electronics Engineers (IEEE) standard such as one or more of the 802.11 standards, etc. In some cases, the wireless communication system 100 may include a device-to-device (D2D) communications network or a short-range communications system, such as Bluetooth communications and near-field communications (NFC).

As illustrated in FIG. 1, the wireless communication system 100 may include a first wireless device 102 communicating with any of various second wireless devices 104a-f (a second wireless device 104) via any of various radio access technologies (RATs), where a wireless device may refer to a wireless communication device. The RATs may include, for example, WWAN communications (e.g., E-UTRA and/or 5G NR), WLAN communications (e.g., IEEE 802.11), vehicle-to-everything (V2X) communications, non-terrestrial network (NTN) communications, short-range communications (e.g., Bluetooth), etc.

The first wireless device 102 may be emitting RF signals in proximity to a human 108, who may be the user of the first wireless device 102 and/or a bystander. As an example, the first wireless device 102 may be held in the hand of the human 108 and/or positioned against or near the head of the human 108. In certain cases, the first wireless device 102 may be positioned in a pocket or bag of the human 108. In some cases, the first wireless device 102 may be positioned proximate to the human 108 as a mobile hotspot. To ensure the human 108 is not overexposed to RF emissions from the first wireless device 102, the first wireless device 102 may control the transmit power associated with the RF signals in accordance with an RF exposure limit, as further described herein, where the RF exposure limit may depend on corresponding exposure scenario (e.g., head exposure, extremity (e.g., hand) exposure, body (body-worn) exposure, hotspot exposure, etc.). Extremities may include, for example, hands, wrists, feet, ankles, and pinnae.

The first wireless device 102 may include any of various wireless communication devices including a user equipment (UE), a wireless station, an access point, a customer-premises equipment (CPE), etc. In certain aspects, the first wireless device 102 includes an RF exposure manager 106 that evaluates time-averaged RF exposure using a filter (e.g., an infinite impulse response filter), in accordance with aspects of the present disclosure.

The second wireless devices 104a-f may include, for example, a base station 104a, an aircraft 104b, a satellite 104c, a vehicle 104d, an access point (AP) 104e, and/or a UE 104f. Further, the wireless communication system 100 may include terrestrial aspects, such as ground-based network entities (e.g., the base station 104a and/or access point 104e), and/or non-terrestrial aspects, such as the aircraft 104b and the satellite 104c, which may include network entities on-board (e.g., one or more base stations) capable of communicating with other network elements (e.g., terrestrial base stations) and/or user equipment.

The base station 104a may generally include: a NodeB (NB), enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. The base station 104a may provide communications coverage for a respective geographic coverage area, which may sometimes be referred to as a cell, and which may overlap in some cases (e.g., a small cell may have a coverage area that overlaps the coverage area of a macro cell). A base station may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

The first wireless device 102 and/or the UE 104f may generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, Internet of things (IoT) devices, always-on (AON) devices, edge processing devices, or other similar devices. A UE may also be referred to more generally as a mobile device, a wireless device, a wireless communications device, a wireless station (STA), a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and other terms.

In certain cases, the first wireless device 102 may control the transmit power used to emit RF signals in compliance with an RF exposure limit. RF exposure may be expressed in terms of a specific absorption rate (SAR), which measures energy absorption by human tissue per unit mass and may have units of watts per kilogram (W/kg). RF exposure may also be expressed in terms of power density (PD), which measures energy absorption per unit area and may have units of milliwatts per square centimeter (mW/cm²). In some cases, the RF exposure may be expressed in terms of a specific energy absorption (SA) limit or an absorbed energy density (Uab) limit, for example, for a total RF energy limit allowed in a specific time period. In certain cases, a maximum permissible exposure (MPE) limit in terms of PD may be imposed for wireless communication devices using transmission frequencies above 6 GHz. Frequency bands of 24 GHz to 71 GHz are sometimes referred to as a “millimeter wave” (“mmW” or “mmWave”). The MPE limit is a regulatory metric for exposure based on area, e.g., an energy density limit defined as a number, X, watts per square meter (W/m²) averaged over a defined area and time-averaged over a frequency-dependent time window in order to prevent a human exposure hazard represented by a tissue temperature change. Certain RF exposure limits may be specified based on a maximum RF exposure metric (e.g., SAR or PD) averaged over a specified time window (e.g., 100 or 360 seconds for sub-6 GHz frequency bands or 2 seconds for 60 GHz bands).

SAR may be used to assess RF exposure for transmission frequencies less than 6 GHz, which cover wireless communication technologies such as 2G/3G (e.g., CDMA), 4G (e.g., E-UTRA), 5G (e.g., NR in sub-6 GHz bands), IEEE 802.11 (e.g., a/b/g/n/ac), etc. PD may be used to assess RF exposure for transmission frequencies higher than 6 GHz, which cover wireless communication technologies such as IEEE 802.11ad, 802.11ay, 5G in mmWave bands, etc. Thus, different metrics may be used to assess RF exposure for different wireless communication technologies.

A wireless device (e.g., the first wireless device 102) may be capable of transmitting signals using multiple wireless communication technologies and/or frequency bands, and in some cases, capable of simultaneous transmission of such signals. For example, the wireless device may transmit signals using a first wireless communication technology operating at or below 6 GHZ (e.g., 3G, 4G, 5G, IEEE 802.11a/b/g/n/ac, etc.) and a second wireless communication technology operating above 6 GHz (e.g., mm Wave 5G in 24 to 60 GHz bands, IEEE 802.11ad or 802.11ay). In certain aspects, the wireless device may transmit signals using the first wireless communication technology (e.g., 3G, 4G, 5G in sub-6 GHz bands, IEEE 802.11ac, etc.) in which RF exposure may be measured in terms of SAR, and the second wireless communication technology (e.g., 5G in 24 to 71 GHz bands, IEEE 802.11ad, 802.11ay, etc.) in which RF exposure may be measured in terms of PD.

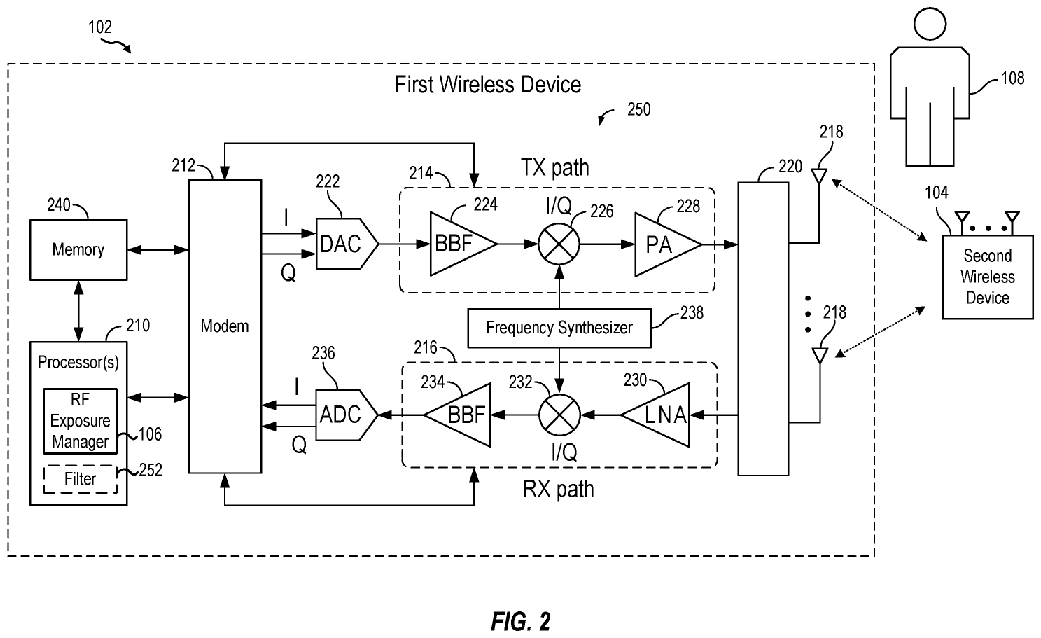

FIG. 2 illustrates example components of the first wireless device 102, which may be used to communicate with any of the second wireless devices 104, in some cases, in proximity to human tissue as represented by the human 108.

The first wireless device 102 may be, or may include, a chip, system on a chip (SoC), chipset, package or device that includes one or more modems 212. In some cases, the modem(s) 212 may include, for example, any of a WWAN modem (e.g., a modem configured to communicate via E-UTRA and/or 5G NR standards), a WLAN modem (e.g., a modem configured to communicate via 802.11 standards), a Bluetooth modem, a NTN modem, etc. In certain aspects, the first wireless device 102 also includes one or more radios (collectively “the radio 250”). In some aspects, the first wireless device 102 further includes one or more processors, processing blocks or processing elements (collectively “the processor 210”) and one or more memory blocks or elements (collectively “the memory 240”).

In certain aspects, the processor 210 may include a processor representative of an application processor that generates information (e.g., application data such as content requests) for transmission and/or receives information (e.g., requested content) via the modem 212. In some cases, the processor 210 may include a microprocessor associated with the modem 212, which may implement the RF exposure manager 106 and/or process any of certain protocol stack layers associated with a radio access technology (RAT). For example, the processor 210 may process any of an application layer, packet layer, WLAN protocol stack layers (e.g., a link or medium access control (MAC) layer), and/or WWAN protocol stack layers (e.g., a radio resource control (RRC) layer, a packet data convergence protocol (PDCP) layer, a radio link control (RLC) layer, and a MAC layer). In some cases, at least one of the modems 212 (e.g., the WWAN modem) may be in communication with one or more of the other modems 212 (e.g., the WLAN modem and/or Bluetooth modem). For example, the processor 210 may be representative of at least one of the modems 212 in communication with one or more of the other modems 212. In certain aspects, the processor 210 may include a filter 252 and may use the filter 252 to evaluate a time-averaged RF exposure as further described herein. As described herein, the filter 252 may be implemented as or comprise an infinite impulse response filter, an integrating filter (e.g., a lossy integrator), or a recursive averaging filter. The filter 252 may enable a time-averaging RF exposure evaluation that tracks the past transmission history associated with one or more time intervals in a time-averaging time window.

The modem 212 may include a hardware block or device such as, for example, an application-specific integrated circuit (ASIC) among other possibilities. The modem 212 may generally be configured to implement a physical (PHY) layer. For example, the modem 212 may be configured to modulate packets and to output the modulated packets to the radio 250 for transmission over a wireless medium. The modem 212 is similarly configured to obtain modulated packets received by the radio 250 and to demodulate the packets to provide demodulated packets. In addition to a modulator and a demodulator, the modem 212 may further include digital signal processing (DSP) circuitry, automatic gain control (AGC), a coder, a decoder, a multiplexer and a demultiplexer (not shown).

As an example, while in a transmission mode, the modem 212 may obtain data from the processor 210. The data obtained from the processor 210 may be provided to a coder, which encodes the data to provide encoded bits. The encoded bits may be mapped to points in a modulation constellation (e.g., using a selected modulation and coding scheme) to provide modulated symbols. The modulated symbols may be mapped, for example, to spatial stream(s) or space-time streams. The modulated symbols may be multiplexed, transformed via an inverse fast Fourier transform (IFFT) block, and subsequently provided to DSP circuitry for transmit windowing and filtering. The digital signals may be provided to a digital-to-analog converter (DAC) 222. In certain aspects involving beamforming, the modulated symbols in the respective spatial streams may be precoded via a steering matrix prior to provision to the IFFT block.

The modem 212 may be coupled to the radio 250 including a transmit (TX) path 214 (also known as a transmit chain) for transmitting signals via one or more antennas 218 and a receive (RX) path 216 (also known as a receive chain) for receiving signals via the antennas 218. When the TX path 214 and the RX path 216 share an antenna 218, the paths may be connected with the antenna via an interface 220, which may include any of various suitable RF devices, such as a switch, a duplexer, a diplexer, a multiplexer, and the like. As an example, the modem 212 may output digital in-phase (I) and/or quadrature (Q) baseband signals representative of the respective symbols to the DAC 222.

Receiving I or Q baseband analog signals from the DAC 222, the TX path 214 may include a baseband filter (BBF) 224, a mixer 226 (which may include one or several mixers), and a power amplifier (PA) 228. The BBF 224 filters the baseband signals received from the DAC 222, and the mixer 226 mixes the filtered baseband signals with a transmit local oscillator (LO) signal to convert the baseband signal to a different frequency (e.g., upconvert from baseband to a radio frequency). In some aspects, the frequency conversion process produces the sum and difference frequencies between the LO frequency and the frequencies of the baseband signal. The sum and difference frequencies are referred to as the beat frequencies. Some beat frequencies are in the RF range, such that the signals output by the mixer 314 are typically RF signals, which may be amplified by the PA 228 before transmission by the antenna 218. The antennas 218 may emit RF signals, which may be received at the second wireless device 104. While one mixer 226 is illustrated, several mixers may be used to upconvert the filtered baseband signals to one or more intermediate frequencies and to thereafter upconvert the intermediate frequency signals to a frequency for transmission.

The RX path 216 may include a low noise amplifier (LNA) 230, a mixer 232 (which may include one or several mixers), and a baseband filter (BBF) 234. RF signals received via the antenna 218 (e.g., from the second wireless device 104) may be amplified by the LNA 230, and the mixer 232 mixes the amplified RF signals with a receive local oscillator (LO) signal to convert the RF signal to a baseband frequency (e.g., downconvert). The baseband signals output by the mixer 232 may be filtered by the BBF 234 before being converted by an analog-to-digital converter (ADC) 236 to digital I or Q signals for digital signal processing. The modem 212 may receive the digital I or Q signals and further process the digital signals, for example, demodulating the digital signals.

Certain transceivers may employ frequency synthesizers with a voltage-controlled oscillator (VCO) to generate a stable, tunable LO frequency with a particular tuning range. Thus, the transmit LO frequency may be produced by a frequency synthesizer 238, which may be buffered or amplified by an amplifier (not shown) before being mixed with the baseband signals in the mixer 226. Similarly, the receive LO frequency may be produced by the frequency synthesizer 238, which may be buffered or amplified by an amplifier (not shown) before being mixed with the RF signals in the mixer 232. Separate frequency synthesizers may be used for the TX path 214 and the RX path 216.

While in a reception mode, the modem 212 may obtain digitally converted signals via the ADC 236 and RX path 216. As an example, in the modem 212, digital signals may be provided to the DSP circuitry, which is configured to acquire a received signal, for example, by detecting the presence of the signal and estimating the initial timing and frequency offsets. The DSP circuitry is further configured to digitally condition the digital signals, for example, using channel (narrowband) filtering, analog impairment conditioning (such as correcting for I/Q imbalance), and applying digital gain to ultimately obtain a narrowband signal. The output of the DSP circuitry may be fed to the AGC, which is configured to use information extracted from the digital signals, for example, in one or more received training fields, to determine an appropriate gain. The output of the DSP circuitry also may be coupled with the demodulator, which is configured to extract modulated symbols from the signal and, for example, compute the logarithm likelihood ratios (LLRs) for each bit position of each subcarrier in each spatial stream. The demodulator may be coupled with the decoder, which may be configured to process the LLRs to provide decoded bits. The decoded bits from all of the spatial streams may be fed to the demultiplexer for demultiplexing. The demultiplexed bits may be descrambled and provided to a medium access control layer (e.g., the processor 210) for processing, evaluation, or interpretation.

The processor 210 and/or modem 212 may control the transmission of signals via the TX path 214 and/or reception of signals via the RX path 216. In some aspects, the processor 210 and/or modem 212 may be configured to perform various operations, such as those associated with any of the methods described herein. The processor 210 and/or the modem 212 may include a microcontroller, a microprocessor, an application processor, a baseband processor, a MAC processor, a neural network processor, a digital signal processor (DSP), an application specific integrated circuit (ASIC), a field programmable gate array (FPGA) or other programmable logic device (PLD), discrete gate or transistor logic, discrete hardware components, or any combination thereof. In some cases, aspects of the processor 210 may be integrated with (incorporated in and/or shared with) the modem 212, such as the RF exposure manager 106, the filter 252, a microcontroller, a microprocessor, a baseband processor, a medium access control (MAC) processor, a digital signal processor, etc. For example, the processor 210 may be representative of a co-processor (e.g., a microprocessor) associated with the modem 212, and the modem 212 may be representative of an ASIC including the baseband processor, MAC processor, DSP, and/or neural network processor. The memory 240 may store data and program codes (e.g., computer-readable instructions) for performing wireless communications as described herein. The memory 240 may be external to the processor 210 and/or the modem 212 (as illustrated) and/or incorporated therein. In certain cases, the RF exposure manager 106 (as implemented via the processor 210 and/or modem 212) may determine a transmit power (e.g., corresponding to certain levels of gain(s) applied to the TX path 214 including the BBF 224, the mixer 226, and/or the PA 228) that complies with an RF exposure limit set by country-specific regulations and/or international guidelines (e.g., International Commission on Non-Ionizing Radiation Protection (ICNIRP) guidelines) as described herein.

FIG. 2 shows an example transceiver design. It will be appreciated that other transceiver designs or architectures may be applied in connection with aspects of the present disclosure. For example, while examples discussed herein utilize I and Q signals (e.g., quadrature modulation), those of skill in the art will understand that components of the transceiver may be configured to utilize any other suitable modulation, such as polar modulation. As another example, circuit blocks may be arranged differently from the configuration shown in FIG. 2, and/or other circuit blocks not shown in FIG. 2 may be implemented in addition to or instead of the blocks depicted. For instance, while the filter 252 is shown separate from the RF exposure manager 106, in certain aspects, the filter 252 may be integral with the RF exposure manager 106. Likewise, while the architecture depicted in FIG. 2 illustrates the filter 252 being implemented within the processor(s) 210, in certain architectures, the filter 252 may be implemented separately from the processors(s), e.g., in a DSP, modem 212, etc. Additionally, those of skill in the art will understand that the filter 252 may be implemented in the digital domain or in the analog domain.

In certain cases, compliance with an RF exposure limit may be performed as a time-averaged RF exposure evaluation within a specified running (moving) time window associated with the RF exposure limit. The RF exposure limit may specify a time-averaged RF exposure metric (e.g., SAR and/or PD) over the running time window. As an example, the Federal Communications Commission (FCC) specifies that certain SAR limits (general public exposure) are 0.08 W/kg, as averaged over the whole body, and a peak spatial-average SAR of 1.6 W/kg, averaged over any 1 gram of tissue (defined as a tissue volume in the shape of a cube) for sub-6 GHz bands, whereas certain PD limits are 1 mW/cm², as averaged over the whole body, and a peak spatial-average PD of 4 mW/cm², averaged over any 1 cm². The FCC also specifies the corresponding averaging time may be 100 seconds for sub-6 GHz bands, whereas the averaging time may be 2 seconds for mmWave bands (e.g., 60 GHz frequency bands) under a proposed regulation, for example.

The RF exposure limit and/or corresponding averaging time window may vary based on the frequency band. In certain aspects, the RF exposure limit(s) and/or corresponding averaging time window(s), if applicable, may be specific to a particular geographic region or country, such as the United States, Canada, China, or European Union. In some cases, the RF exposure limit(s) may specify the maximum allowed RF exposure that can be encountered without time averaging. In such cases, the maximum allowed RF exposure may correspond to a maximum output or transmit power that can be used by the wireless device.

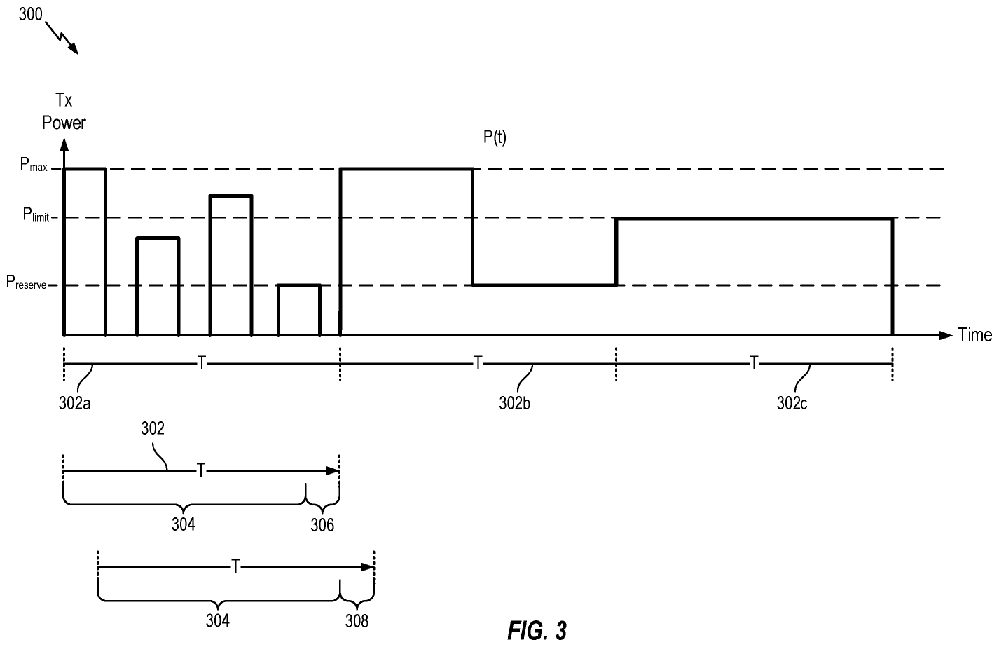

FIG. 3 is a graph 300 of a transmit power over time (P (t)) that varies over a running (e.g., rolling or moving) time window (T) associated with the RF exposure limit. The wireless device (e.g., the first wireless device 102) may evaluate RF exposure compliance over the running time window 302(T) based on past RF exposure (e.g., a transmit power report) in a past time interval 304 of the time window 302 and a future time interval 306. The wireless device may determine the maximum allowed transmit power for the future time interval 306 that satisfies the time-averaged RF exposure limit based on the past RF exposure used in the past time interval 304. The wireless device may perform such a time-averaging evaluation as the time window 302 moves over time, for example, in the next future time interval 308, where the past time interval 304 now includes the previous future time interval 306.

The maximum time-averaged transmit power limit (Pₗᵢₘᵢₜ) represents the maximum transmit power the wireless device can transmit continuously for the duration of the running time window 302(T) in compliance with the RF exposure limit. For example, the wireless device is transmitting continuously at Pₗᵢₘᵢₜ in the third time window 302c such that the time-averaged transmit power over the time window (e.g., the third time window 302c) is equal to Pₗᵢₘᵢₜ in compliance with the time-averaged RF exposure limit. The RF exposure level corresponding to time-averaged transmit power limit (Pₗᵢₘᵢₜ) may be referred to as an RF exposure design target. The RF exposure design target may be less than or equal to the RF exposure limit. The RF exposure design target is typically selected to be less than the RF exposure limit for one or more reasons, such as to account for device uncertainty, to meet RF exposure limit in exposure scenarios that involve transmitting simultaneously with other radios within the same device that have a different RF exposure controlling schemes, to have lower RF exposure for the device, etc.

In certain cases, an instantaneous transmit power may exceed Pₗᵢₘᵢₜ in certain transmission occasions, for example, as shown in the first time window 302a and the second time window 302b. In some cases, the wireless device may transmit at Pₘₐₓ, which may be the maximum instantaneous transmit power supported by the wireless device, the maximum instantaneous transmit power the wireless device is capable of outputting, or the maximum instantaneous transmit power allowed by a standard or regulatory body (e.g., the maximum output power, PCMAX). In some cases, the wireless device may transmit at a transmit power less than or equal to Pₗᵢₘᵢₜ in certain transmission occasions, for example, as shown in the first time window 302a.

In certain cases, a reserve power may be used to enable a continuous transmission within a time window (T) when transmitting above Pₗᵢₘᵢₜ in the time window or to enable a certain level of quality for certain transmissions. As shown in the second time window 302b, the transmit power may be backed off from Pₘₐₓ to a reserve power (Pᵣₑₛₑᵣᵥₑ) so that the wireless device can maintain a continuous transmission during the time window (e.g., maintain a radio connection with a receiving entity) in compliance with the time-averaged RF exposure limit. In the third time window 302c, the wireless device may increase the transmit power to Pₗᵢₘᵢₜ in compliance with the time-averaged RF exposure limit. In some cases, Pᵣₑₛₑᵣᵥₑ may allow for a certain level of transmission quality for certain transmissions (e.g., control signaling). Pᵣₑₛₑᵣᵥₑ may be used to reserve transmit power for at least a portion of the time window 302 for certain transmissions (e.g., control signaling).

In the second time window 302b, the total area of transmit power (P (t)) in the second time window 302b is equal to the area of Pₗᵢₘᵢₜ for the time window T. Such an area may be considered using 100% of the energy (transmit power or exposure) to remain compliant with the time-averaged RF exposure limit. Without the reserve power Pᵣₑₛₑᵣᵥₑ, the transmitter may transmit at Pₘₐₓ for a portion of the time window with the transmitter turned off for the remainder of the time window to ensure compliance with the time-averaged RF exposure limit. Note, if Pᵣₑₛₑᵣᵥₑ is half of Pₗᵢₘᵢₜ in the second window 302b, then the area between Pₘₐₓ and Pᵣₑₛₑᵣᵥₑ for the time duration of transmitting at Pₘₐₓ may be equal to the area between Pₗᵢₘᵢₜ and Pᵣₑₛₑᵣᵥₑ for the time window T.

In some aspects, the wireless device may transmit at a power that is higher than Pₗᵢₘᵢₜ, but less than Pₘₐₓ in the time-averaged mode illustrated in the second time window 302b. While a single transmit burst is illustrated in the second time window 302b, it will be understood that the wireless device may instead utilize a plurality of transmit bursts within the time window (T), where the transmit bursts are separated by periods during which the transmit power is maintained at or below Pᵣₑₛₑᵣᵥₑ only if at least a portion of the transmit bursts may be transmitted at a power above Pₗᵢₘᵢₜ.

In certain aspects, the wireless device may transmit at a power less than or equal to a fixed power limit (e.g., Pₗᵢₘᵢₜ) without considering past exposure and/or past transmit powers in terms of a time-averaged RF exposure. For example, the wireless device may transmit at a power less than or equal to Pₗᵢₘᵢₜ using a look-up table (comprising one or more values of Pₗᵢₘᵢₜ depending on an RF exposure scenario). The look-up table may provide one or more values of Pₗᵢₘᵢₜ depending on the transmit frequency, transmit antenna, radio configuration (single-radio or multi-radio) and/or RF exposure scenario (e.g., a device state index corresponding to head exposure, body or torso exposure, extremity or hand exposure, and/or hotspot exposure) encountered by the wireless device. Examples of RF exposure scenarios include cases where the wireless device is emitting RF signals proximate to human tissue, such as a user's head, hand, or body (e.g., torso), or where the wireless device is being used as a hotspot away from human tissue. Therefore, the RF exposure can be managed as a time-averaged RF exposure evaluation (e.g., illustrated in FIG. 3), managed using a look-up table or flat or maximum value, or using another strategy or algorithm, where a particular process of managing the RF exposure may be referred to herein as an RF exposure control scheme.

For certain aspects, a wireless device may exhibit or be configured with a transmission duty cycle. The wireless device may determine transmit power level(s) and/or reserve power level(s) in compliance with the time-averaged RF exposure limit based on the duty cycle. The transmission duty cycle may be indicative of a share (e.g., 100 ms) of a specific period (e.g., 500 ms) in which the wireless device transmits RF signals. The duty cycle may be a ratio of the share to the specific period (e.g., 100 ms/500 ms), where the duty cycle may be represented as a number from zero to one. The duty cycle may be an effective duty cycle associated with a total transmit time of one or more transmissions in the time period, where the one or more transmissions may include bursts of transmissions having a gap of time positioned between at least two of the bursts. For example, in the first time window 302a, the duty cycle may be greater than 50% of the duration of the time window (T), whereas in the second time window 302b, the duty cycle may be equal to 100% of the duration of the time window (T). In certain cases, the duty cycle may be standardized (e.g., predetermined) with a specific RAT and/or vary over time, for example, due to changes in radio conditions, mobility, and/or user behavior.

As an example, certain RATs may specify the uplink duty cycle in the form of a time division duplexing (TDD) configuration, such as a TDD uplink-downlink (UL-DL) slot pattern in 5G NR or similar TDD patterns in E-UTRA or UMTS. In 5G NR, the TDD UL-DL slot pattern may specify the number of uplink slots and corresponding position in time associated with the uplink slots in a sequence of slots, such that the total number of uplink slots with respect to the total number of slots in the sequence is indicative of the duty cycle. In certain aspects, the duty cycle may correspond to the actual duration for past transmissions scheduled or used, for example, within the TDD UL-DL slot pattern. For example, although the wireless device may be configured with a TDD UL-DL slot pattern, the wireless device may use a portion or subset of the UL slots for transmitting RF signals. Thus, the duty cycle for the wireless device may be less than the maximum available duty cycle corresponding to the TDD UL-DL slot pattern.

In certain cases, a wireless device may track the transmit power history as normalized RF exposures across a sequence of time intervals in a time-averaging time window. As an example, a normalized RF exposure (Δt.NE.report) for a past time interval (referred to herein as a normalized RF exposure (NE) report) may be expressed as:

$$Δ t . NE . report = \frac{{TX}_{avg \_Δ t}}{{P}_{limit}} \qquad ( 1 )$$

where TX_{avg_Δt} is the averaged transmit power over a past time interval Δt (e.g., 500 ms), and Pₗᵢₘᵢₜ is the maximum time-averaged transmit power level corresponding to a time-averaged RF exposure limit, for example, as described herein with respect to FIG. 3. In some cases, Pₗᵢₘᵢₜ may be set to a transmit power level less than the specified regulatory limit, for example, to account for device uncertainties, such as variations in transmit power levels associated with mass-produced devices, the operating life, the operating temperature, voltage, and/or current, etc. In certain aspects, the average transmit power may account for the transmission duty cycle.

The past normalized exposure reports (e.g., N−1) may be averaged over the past time-averaging time window less one of the time intervals in order to determine the allowed transmit power for a future time interval Δt, such that the normalized average is less than or equal to the normalized RF exposure limit (e.g., 1.0). Here, N=T/Δt, where T is the regulatory time window for averaging RF exposure.

The normalized exposure for a future time interval (NE_{future}) may be determined as follows:

$${NE}_{future} = 1 - ( \frac{1}{N} ) {\sum }_{1}^{N - 1} [ Δ t . NE . report ( i ) ] \qquad ( 2 )$$

where T is the time-averaging time window associated with a time-averaged RF exposure limit (e.g., a regulatory time window or a time window in compliance with (e.g., shorter than) a regulatory time window), and N is the total number of time intervals used to track the transmission history (e.g., N=T/Δt).

The maximum allowed transmit power (TX_{future}) for the future time interval in compliance with the RF exposure limit may be determined as follows:

$${TX}_{future} = {NE}_{future} \cdot N \cdot {P}_{limit} . \qquad ( 3 )$$

The above examples demonstrate a time-averaging RF exposure evaluation that does not maintain a reserve power level (e.g., Pᵣₑₛₑᵣᵥₑ) as described herein with respect to FIG. 3.

In certain aspects, the wireless device may maintain a reserve power level (e.g., Pᵣₑₛₑᵣᵥₑ), for example, as described herein with respect to FIG. 3. In order to maintain a reserve power level, the wireless device may adjust the normalized exposure report (Δt.NE.report) to account for the reserve power level and determine the high exposure portion of the normalized exposure report, for example, as follows:

$$Δ t . high . NE . report = max \{ Δ t . NE . report - reserve , 0 \} \qquad ( 4 )$$

where reserve represents the normalized reserve power level (e.g., Pᵣₑₛₑᵣᵥₑ/Pₗᵢₘᵢₜ). The wireless device may determine the high exposure portion as the largest value among zero and the difference between the normalized exposure report and the reserve level.

With the reserve level, the high exposure portion of the normalized exposure for a future time interval (NE_{future}) may be determined as follows:

$$high . {NE}_{future} = 1 - ( \frac{1}{N} ) {\sum }_{1}^{N - 1} [ Δ t . high . NE . report ( i ) ] - reserve . \qquad ( 5 )$$

While maintaining the reserve level, the maximum allowed transmit power (TX_{future}) for the future time interval in compliance with the RF exposure limit may be determined as follows:

$${NE}_{future} = ( high . {NE}_{future} \cdot N + reserve ) \qquad ( 6 )$$

$${TX}_{future} = {NE}_{future} \cdot {P}_{limit} = ( high . {NE}_{future} \cdot N + reserve ) \cdot {P}_{limit} .$$

Even if the high exposure portion of the normalized exposure for a future interval (high.NE_{future}) goes to zero, Expression (6) may effectively ensure the reserve is available by adding the reserve to the normalized exposure for the future time interval (NE_{future}).

The time-averaging RF exposure evaluation (with or without a reserve level) performed by certain wireless devices may use past (N−1) normalized exposure reports to determine the maximum allowed transmit power on a periodic basis. Such a time-averaging evaluation may use storage resources and processing resources. For example, the wireless device may store the past N−1 reports in memory and update the reports on a rolling basis (e.g., every Δt=500 ms). The wireless device may have the processing capabilities (e.g., latency, clock rate, throughput, channel capacity, processing time, etc.) to determine the maximum allowed transmit power for a future time interval within the time interval (e.g., 500 ms). A higher N (e.g., lower Δt) may result in a higher allowed transmit power for a future time interval (see, e.g., Expression (6)) as discrete time-averaging approaches an ideal time-averaging (e.g., N=0). However, as N increases for the time-averaging evaluation, the complexity of the computational resources (e.g., processing resources and/or memory resources) may also increase.

Certain wireless devices (e.g., an Internet of things (IoT) device, a low-cost cellular phone, or a wireless device with a relatively simple RF exposure control scheme) may lack the capability to store the transmit power history and/or perform the processing at a granularity of 500 milliseconds per time interval across an entire time-averaging time window, for example, due to the wireless device having a certain amount of memory (e.g., low memory for modem operations) and/or computational power for computational operations. Instead of time-averaging, the wireless device may only allow transmit powers to be less than or equal to a maximum time-averaged transmit power (e.g., Pₗᵢₘᵢₜ) corresponding to the time-averaged RF exposure limit. In such cases, the wireless device may not be able to transmit above the maximum time-averaged transmit power regardless of the past transmission history associated with the wireless device. In some cases, the wireless device may run a time-averaging RF exposure evaluation using time intervals with longer Δt durations (e.g., storing a transmit power every five seconds, resulting in lower N). Here too, the wireless device may operate at a lower peak power compared to a time-averaging evaluation using shorter time intervals. Therefore, such devices may transmit at reduced power levels compared to other devices, resulting in, for example, reduced throughput, higher latencies, and/or a reduced transmission range.

### Example Filter-Based Time-Averaged RF Exposure Evaluation

Aspects of the present disclosure provide apparatus and methods for evaluating time-averaged RF exposure using a filter. A wireless device may determine an effective time-averaged normalized RF exposure associated with past transmission(s) using the filter, such as an infinite impulse response (IIR) filter, an integrating filter (e.g., a lossy integrator), or a recursive averaging filter, as illustrative, non-limiting examples. The filter may enable a time-averaging RF exposure evaluation that tracks the past transmission history associated with only a single time interval (e.g., 500 ms) in a time-averaging time window. For example, the filter may apply a variation of a recursive averaging filter (or a non-recursive averaging filter) using a scaling factor that estimates a time-averaging operation, as further described herein. Such a time-averaging RF exposure evaluation may allow certain wireless devices (e.g., a wireless device with limited resources, such as IoT devices, low-memory devices, low-cost devices, etc.) to transmit in compliance with a time-averaged RF exposure limit and improve wireless communication performance.

The apparatus and methods for evaluating time-averaged RF exposure described herein may provide various advantages. For certain wireless devices (e.g., a low-memory device, IoT device, low-cost cellular phone, etc.), the apparatus and methods may improve wireless communication, including, for example, an increased throughput, decreased latency, and/or increased transmission range, where the improved performance may be attributable to using a filter that estimates a moving time-averaged window.

In certain aspects, the wireless device may perform a time-averaging RF exposure evaluation using an IIR filter. When beginning the time-averaging RF exposure evaluation (e.g., on start-up, boot-up, or transitioning from an idle mode), the wireless device may optionally set a past time-averaged normalized exposure to a default value (e.g., IIR.NE.report.avg=0, where IIR.NE.report.avg represents the time-averaged normalized exposure over the past time-averaging time window). An effective time-averaged normalized exposure in the time-averaging time window may be determined using a recursive time-averaging filter as follows:

$$IIR . NE . report . avg = α * Δ t . NE . report + ( 1 - α ) * IIR . NE . report . {avg}_{prev} \qquad ( 7 )$$

where α is a scaling factor used to emulate time-averaging in the recursive expression, and IIR.NE.report.avgₚᵣₑᵥ is the time-averaged normalized exposure determined for the previous time interval (Δt). In certain aspects, IIR.NE.report.avgₚᵣₑᵥ may be set to a particular value including, for example, a normalized exposure corresponding to Pₗᵢₘᵢₜ, Pₘₐₓ, or the peak transmit power used in the past time interval or the time-averaging time window. The wireless device may determine the effective time-averaged normalized exposure IIR.NE.report.avg based on the normalized exposure (Δt.NE.report) for the past time interval on a periodic basis, for example, every 500 ms. In some cases, the effective time-averaged normalized exposure IIR.NE.report.avg may be greater (i.e., over-estimation in time-averaged exposure) than a running time-average, for example,

$$( \frac{1}{N} ) {\sum }_{1}^{N - 1} [ Δ t . NE . report ( i ) ] ,$$

The scaling factor (α) may be set to a value that enables the recursive expression—Expression (7)—to emulate time-averaging, for example, as described herein with respect to Expression (2). In some cases, the scaling factor (α) may be determined based on the number of effective time intervals (N) used in the time-averaging evaluation. For example, the scaling factor (a) may be equal to the reciprocal of the number of time intervals (e.g., α=(1/N)). In certain cases, the scaling factor may be based on an adjusted reciprocal of the number of time intervals, for example, according to the following:

$$α = β \cdot ( 1 / N )$$

where β is an adjustment factor, which may be set to a value greater than 1, for example. β may be determined via simulation or testing for different transmission scenarios (e.g., antenna, frequency band, RAT, time window (T) duration, time interval (Δt) duration, reserve power level, a transmission pattern, duty cycle, Pₘₐₓ, Pₗᵢₘᵢₜ, and/or N) such that the IIR filter output, IIR.NE.report.avg, provides a conservative (i.e., higher value) estimate when compared to running time-average operation,

$$( \frac{1}{N} ) {\sum }_{1}^{N - 1} [ Δ t . NE . report ( i ) ] .$$

A transmission pattern may correspond to a transmission signature for transmit power versus time. As an example, α=0.0125 for 201 averaging time intervals (100 s window/0.5 s+1 future time interval=201 time intervals), or α=0.0018 for 721 averaging time intervals (360 s window/0.5 s+1 future time interval=721 time intervals).

In certain aspects, the wireless device may use a special maximum time-averaged transmit power level (Pₗᵢₘᵢₜ) to ensure compliance when applying the effective time-averaged exposure (or corresponding transmit power). If the effective time-averaged normalized exposure does not yield a transmit power in compliance with the RF exposure limit for all transmission scenarios, the wireless device may apply an adjusted (e.g., reduced) maximum time-averaged transmit power level (Pₗᵢₘᵢₜ′) to ensure compliance with the RF exposure limit (e.g., Pₗᵢₘᵢₜ′ (dBm)=Pₗᵢₘᵢₜ (dBm)−delta_dB, where delta_dB is the adjustment factor to account for the margin of error associated with the filter-based time-averaging). For certain aspects, the wireless device may use a combination of an adjusted a and a reduced Pₗᵢₘᵢₜ to achieve IIR filter time-averaged exposure in compliance with the RF exposure limit.

In certain aspects, the wireless device may perform a time-averaging RF exposure evaluation using a higher-order IIR filter, where Expression (7) is modified to represent an n^{th}-order IIR filter as shown below:

$$IIR . NE . report . avg [ i ] = {\sum }_{k = 1}^{n 1} ( {α}_{k} * Δ t . NE . report [ i - k - 1 ] ) + {\sum }_{k = 1}^{n 2} ( {γ}_{k} * IIR . NE . report . avg [ i - k ] ) \qquad ( 8 )$$

where, n>0 represents the order of the IIR filter, αₖ represent the coefficients for scaling the past normalized exposure reports (Δt.NE.report [i−k−1]), γₖ represent the coefficients for scaling the past time-averaged filter value (IIR.NE.report.avg [i−k]), [i] represents values in i^{th} iteration, k represents the number of time intervals (Δt) delay, and [i−k] represents values from k*Δt time intervals ago (for example, [i−1] represents values from previous time interval). When beginning the time-averaging RF exposure evaluation (e.g., on start-up, boot-up, or transitioning from an idle mode), the wireless device may optionally initialize all the past normalized exposure reports (Δt.NE.report [i−k−1]) and past time-averaged filter values (IIR.NE.report.avg [i−k]) to zero. If n1=n2=1, αₖ=α, and γₖ=1−α, then Expression (8) reduces to Expression (7). This n^{th}-order IIR filter given in Expression (8) may provide a more accurate approximation of running time-average,

$$( \frac{1}{N} ) {\sum }_{1}^{N - 1} [ Δ t . NE . report ( i ) ] ,$$

then compared to the 1^{st}-order IIR filter given in Expression (7). For example, in a particular case, if n1=N, n2=0, αₖ=1/N, and γₖ=0, then Expression (8) is the same as running time-average,

$$( \frac{1}{N} ) {\sum }_{1}^{N - 1} [ Δ t . NE . report ( i ) ] .$$

However, this accuracy (e.g., lower delta_dB adjustment that results in higher wireless communication performance) of an n^{th}-order IIR filter may come at a cost of higher computations and higher storage. For example, the n^{th}-order IIR filter in Expression (8) may involve (n1+n2) multiplications and (n1+n2−1) additions for each run of the IIR filter, and may involve storing n1 past normalized exposure reports (Δt.NE.report [i−k−1]) as well as associated αₖ coefficients and n2 past time-averaged filter values (IIR.NE.report.avg [i−k]), as well as associated γₖ coefficients. Therefore, selection of an n^{th}-order IIR filter is a wireless communication performance versus computation tradeoff.

With the effective time-averaged normalized exposure, the normalized exposure for a future time interval (NE_{future}) may be determined as follows:

$${NE}_{future} = 1 - IIR . NE . report . avg . \qquad ( 9 )$$

With respect to the effective time-averaged normalized exposure, the maximum allowed transmit power (TX_{future}) for the future time interval in compliance with the RF exposure limit may be determined, for example, according to Expression (3).

In certain aspects, the wireless device may maintain a reserve power level available for transmission(s), for example, as described herein with respect to FIG. 3. With a reserve power level, an effective time-averaged normalized exposure in the time-averaging time window may be determined using a recursive time-averaging filter as follows:

$$IIR . high . NE . report . avg = α * max \{ Δ t . NE . report - reserve , 0 \} + ( 1 - α ) * IIR . high . NE . report . {avg}_{prev} \qquad ( 10 )$$

where IIR.high.NE.report.avgₚᵣₑᵥ represents the average high exposure portion of a normalized exposure report for a past time interval (Δt). In some aspects, IIR.high.NE.report.avgₚᵣₑᵥ may be set to a particular value including, for example, Pₗᵢₘᵢₜ, Pₘₐₓ, and/or the peak transmit power used in the past time interval or time-averaging time window. The particular value for the IIR.high.NE.report.avgₚᵣₑᵥ may be independent of the previous effective time-averaged exposure (e.g., non-recursive) in certain conditions, such as boot-up, lack of transmissions, or a period of unknown transmissions, as illustrative, non-limiting examples. In certain aspects, IIR.high.NE.report.avg may be determined using an n^{th}-order IIR filter as shown below:

$$IIR . high . NE . report . avg [ i ] = {\sum }_{k = 1}^{n 1} ( {α}_{k} * max \{ Δ t . NE . report [ i - k - 1 ] - reserve , 0 \} ) + {\sum }_{k = 1}^{n 2} ( {γ}_{k} * IIR . high . NE . report . avg [ i - k ] ) \qquad ( 11 )$$

With the effective time-averaged normalized exposure and the reserve power level, the high exposure portion of the normalized exposure for a future time interval (NE_{future}) may be determined as follows:

$$high . {NE}_{future} = 1 - IIR . high . NE . report . avg - reserve . \qquad ( 12 )$$

With respect to the effective time-averaged normalized exposure and the reserve power level, the maximum allowed transmit power (TX_{future}) for the future time interval in compliance with the RF exposure limit may be determined, for example, according to Expression (6). In some cases, the wireless device may take into account or consider a duty cycle in determining the maximum allowed transmit power (TX_{future}). For example, the maximum allowed transmit power as determined according to Expression (6) may be divided by a ratio of the duty cycle.

In certain aspects, when the wireless device does not transmit for a time period (for example, due to the wireless device being idle, powered off, or in airplane mode), the wireless device may update the effective time-averaged normalized exposure for each time interval (Δt) the wireless device refrained from transmitting. For example, if the wireless device does not transmit for a time t_sleep, the IIR.high.NE.report may be updated with respect to the idle period for m (=t_sleep/Δt) iterations. For example, IIR.high.NE.report.avg=(1−α)^{m}·IIR.high.NE.report.avgₚᵣₑᵥ. In other words, for all idle iterations, the wireless device may set Δt.NE.report to zero with respect to Expressions (7), (8), (10), or (11). If the wireless device refrains from transmitting for a time period greater than or equal to the time-averaging time window (e.g., t_sleep>T), the effective time-averaged normalized exposure (e.g., IIR.NE.report.avg or IIR.high.NE.report.avg) may be set to a default value, for example, zero.

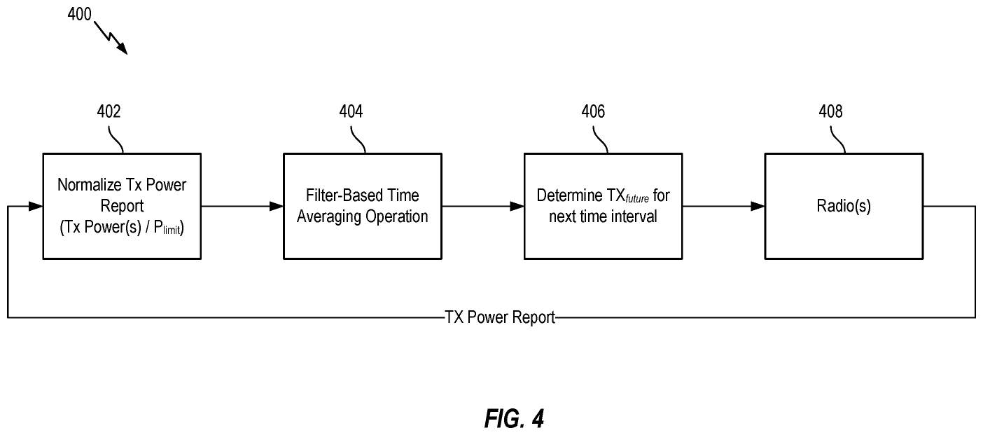

FIG. 4 is a flow diagram illustrating example operations 400 for ensuring compliance with a time-averaged RF exposure limit using a filter (e.g., filter 252) that emulates a rolling time-averaging evaluation. The operations 400 may be performed, for example, by a wireless device (e.g., the first wireless device 102). In certain aspects, an RF exposure manager (e.g., RF exposure manager 106) implemented via one or more processors (e.g., processor 210 and/or modem 212) may perform the operations 400. Certain of the operations 400 may be implemented by components other than the RF exposure manager 106 (e.g., by one or more radios). The wireless device may repeat the operations 400 on a periodic time interval, for example, every 500 ms, 1 second, etc.

The operations 400 may optionally begin, at block 402, where the wireless device may obtain the transmit power(s) used for a particular time interval (e.g., the time interval 306) in a time window (T) associated with a time-averaged RF exposure limit. The wireless device may determine a normalized power report of the past transmit power(s) relative to Pₗᵢₘᵢₜ, for example, as described herein with respect to Expression (1).

The transmit power may be obtained from a radio (e.g., the radio 250) that applied the transmit power(s) in the time interval. In certain aspects, the processor 210 and/or the modem 212 may obtain (or access) the transmit power used for the particular time interval from the radio 250. For example, the processor 210 and/or the modem 212 may track the transmit power(s) used by the transmit path 214 over time as reported by the radio 250 in a transmit power report, to the processor 210 and/or the modem 212. A transmit power report of the past transmit powers (e.g., the past transmit powers used in the time interval 306) may be representative of actual transmit power(s) within an expected device uncertainty.

At block 404, the wireless device may perform a time-averaging operation using a filter (e.g., filter 252) that emulates a running time-averaged window, for example, using Expressions (7), (8), (10), or (11). The wireless device may determine an effective time-averaged normalized exposure (or corresponding transmit power), for example, using a recursive averaging filter or an exponentially weighted moving average. The wireless device may determine a normalized exposure margin allowed for the next time interval (e.g., the time interval 308) in the time window (T) such that the time average of the normalized power report and the exposure margin for the next time interval satisfy the RF exposure limit or design target, for example, according to Expression (9) or Expression (12). In certain aspects, the exposure margin may be the maximum RF exposure that the wireless device can produce and satisfy the RF limit or design target. The normalized exposure margin may be the percentage of exposure remaining with respect to the normalized power report and the RF exposure limit or design target. For example, the normalized RF exposure design target may be satisfied when the sum of the effective time-averaged exposure and the exposure margin for the next time interval is less than or equal to one (e.g., the normalized RF exposure limit or design target).

At block 406, the wireless device may determine the maximum allowed transmit power (TX_{future}) for the next time interval (e.g., the time interval 308), for example, according to Expression (3) or Expression (6). For example, the maximum allowed transmit power (TX_{future}) may be equal to the product of the normalized exposure margin, Pₗᵢₘᵢₜ, and the number of time-averaging bins (or averaging time intervals).

At block 408, the wireless device may provide the maximum allowed transmit power to transceiver circuitry (e.g., the radio 250). For example, the radio 250 may obtain the maximum allowed transmit power as digital RF information (e.g., a particular gain index associated with an output power of the transmit path 214), and the radio 250 may control the gains applied to circuitry in the transmit path to output a signal (e.g., an analog RF signal) at the transmit power associated with the digital RF information. The radio 250 may provide the actual transmit power used as a transmit power report to the processor 210 and/or the modem 212 for determining the transmit power to be used in the next time interval.

The filter-based time-averaging techniques described herein may allow the wireless device to implement a time-averaging RF exposure evaluation without storing past exposures (or corresponding transmit powers) for the entire duration of the time-averaging time window and without computing a rolling time-averaged exposure (or corresponding transmit power), for example, based on Expression (2) or Expression (5). The filter-based time-averaging approach described herein may allow the wireless to implement the time-averaging RF exposure evaluation using only a single past transmit power report (Δt.NE.report) and a previous effective time-averaged exposure (IIR.NE.report.avgₚᵣₑᵥ or IIR.high.NE.report.avgₚᵣₑᵥ). The filter (e.g., an IIR-based filter) may determine the effective time-averaged exposure using an uncomplicated computation via the recursive averaging, for example, based on Expression (7) or Expression (10). In certain aspects, the effective time-averaged exposure may be determined using an n^{th}-order IIR filter, for example, based on Expression (8) or Expression (11), that may involve storing n1 single past transmit power reports (Δt.NE.report [i−k−1]) and n2 past effective time-averaged exposure values (IIR.NE.report.avgₚᵣₑᵥ or IIR.high.NE.report.avgₚᵣₑᵥ).

The filter-based time-averaging may be applied to any of various RF exposure concepts. For example, the filter-based time-averaging may apply multiple reserves (e.g., reserves for certain communications, control signaling, high priority transmissions, etc.), antenna groups (e.g., mutually exclusive antenna groups in terms of RF exposure tracking), RF exposure locations (e.g., mutually exclusive tracking of RF exposure for certain body positions), multi-radio compliance (e.g., transmissions output by multiple radios in the same time interval (Δt)), etc. In some cases, the filter-based time-averaging approach may take into account or consider the duty cycle of transmissions when determining the transmit power in compliance with an RF exposure limit.

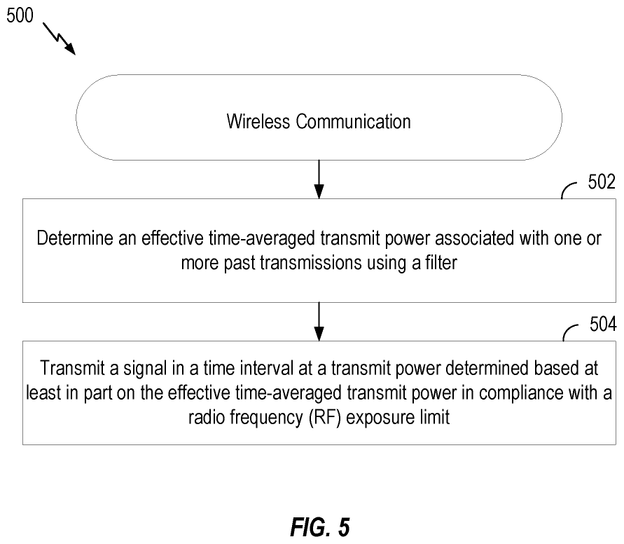

FIG. 5 is a flow diagram illustrating example operations 500 for wireless communication. The operations 500 may be performed, for example, by a wireless device (e.g., the first wireless device 102 in the wireless communication system 100). The operations 500 may be implemented as software components that are executed and run on one or more processors (e.g., the processor 210 and/or the modem 212 of FIG. 2). For example, an RF exposure manager (e.g., RF exposure manager 106) implemented via the one or more processors may perform the operations 500 or cause the operations to be performed. Further, the transmission and/or reception of signals by the wireless device in the operations 500 may be enabled, for example, by one or more antennas (e.g., antennas 218 of FIG. 2). In certain aspects, the transmission and/or reception of signals by the wireless device may be implemented via a bus interface of one or more processors (e.g., the processor 210 and/or the modem 212) obtaining and/or outputting signals for reception or transmission.

The operations 500 may optionally begin, at block 502, where the wireless device may determine an effective time-averaged transmit power (or normalized exposure) associated with one or more past transmissions using a filter (e.g., filter 252). The effective time-averaged transmit power may correspond to a normalized RF exposure, for example, as normalized via a maximum time-averaged transmit power level (e.g., Pₗᵢₘᵢₜ). For simplicity, aspects of the present disclosure may be focused on performing the filter-based time-averaging evaluation in part in terms of normalized RF exposures (due to a transmit power level being proportional to an RF exposure level), for example, as described herein with respect to Expressions (1)-(12). In certain aspects, the filter may be based on an IIR filter and/or an integrating filter (e.g., a lossy integrator). In some cases, the filter may include a recursive averaging filter or an exponentially weighted moving average. In certain cases, the filter may include a non-recursive averaging filter that applies a particular value for the previous evaluation, for example, as described herein with respect to Expression (7) or Expression (10). In certain aspects, effective time-averaged exposure may be determined using an n^{th}-order IIR filter, for example, based on Expression (8) or Expression (11).

At block 504, the wireless device may transmit a signal in a time interval (e.g., the time interval 306) at a transmit power determined based at least in part on the effective time-averaged transmit power in compliance with an RF exposure limit. For example, the wireless device may transmit the signal to another wireless communication device (e.g., any of the second wireless devices 104 depicted in FIG. 1). The signal may indicate (or represent or carry) any of various information, such as data and/or control information. In some cases, the signal may indicate (or represent or carry) one or more packets or data blocks.

In certain aspects, the wireless device may determine an effective time-averaged normalized exposure corresponding to an effective time-averaged transmit power, for example, as described herein with respect to Expression (7), Expression (8), and/or For Expression (10). example, IIR.NE.report.avg and/or IIR.high.NE.report.avg may represent an effective time-averaged normalized exposure. The wireless device may determine the effective time-averaged normalized exposure (or transmit power) based at least in part on (i) a time-averaged transmit power (e.g., TX_{avg_Δt} and/or Δt.NE.report) for a single time interval (e.g., a past time interval, Δt) or a time-averaged transmit power (e.g., Δt.NE.report [i−k−1]) for multiple past time intervals, (ii) a scaling factor (e.g., a), and (iii) a previous filter value (e.g., IIR.NE.report.avgₚᵣₑᵥ, IIR.high.NE.report.avgₚᵣₑᵥ). The previous filter value may correspond to the effective time-averaged exposure from a previous time interval (IIR.NE.report.avgₚᵣₑᵥ) and/or a time-averaging time window (IIR.high.NE.report.avgₚᵣₑᵥ). In certain aspects, the previous filter value may be set to a particular value independent of the previous effective time-averaged exposure in certain conditions, such as boot-up, lack of transmissions, or a period of unknown transmissions, as illustrative, non-limiting examples. The single time interval may have a shorter duration (e.g., 500 ms) than the time-averaging time window (e.g., 100 s, 360 s, etc.) for RF exposure compliance. The wireless device may determine a first term as a product of the scaling factor and a largest value among a default value (e.g., 0) and a difference between the time-averaged transmit power and a reserve level (e.g., α*max {Δt.NE.report−reserve, 0}, as provided in Expression (10)). The wireless device may determine a second term as a product of the previous filter value and a difference between one and the scaling factor (e.g., (1−α)*IIR.high.NE.report.avgₚᵣₑᵥ). The wireless device may determine the effective time-averaged normalized exposure (or transmit power) as a sum of the first term and the second term.

The wireless device may determine an RF exposure (or transmit power) budget for a future time interval (e.g., the time interval 306), for example, according to Expression (9) or Expression (12). The wireless device may determine a normalized transmit power budget based at least in part on a reserve level and the effective time-averaged transmit power, for example, according to Expression (12). The wireless device may convert the normalized transmit power budget to a maximum allowed transmit power (TX_{future}) for the time interval. The transmit power used at block 504 may be less than or equal to the maximum allowed transmit power. In certain aspects, the wireless device may convert the normalized transmit power budget to the maximum allowed transmit power using a duty cycle associated with one or more transmissions.

In certain aspects, to perform the filter-based time-averaging evaluation as described herein, the wireless device may take into account or consider time period(s) when the wireless device refrained from transmitting in the time-averaging time window. For example, the wireless device may determine that no past transmissions have occurred in the time-averaging time window, and the wireless device may set the effective time-averaged transmit power to a particular value (e.g., 0) in response to determining no past transmissions have occurred in the time-averaging time window. If for some duration in the time-averaging time window the wireless device refrained from transmitting (but not the full duration of the time window), then the wireless device may determine the effective time-averaged normalized exposure (or transmit power) using a default value (e.g., 0) for the transmit power reports(s). For example, the wireless device may determine that no past transmissions have occurred in one or more past time intervals during the time-averaging time window, and the wireless device may determine the effective time-averaged normalized exposure (or transmit power) using a default transmit power (e.g., 0) for the one or more past time intervals in response to determining no past transmissions have occurred in the one or more past time intervals.

For certain aspects, the wireless device may lack the capability to perform a running time-averaging evaluation, for example, due to having certain resource(s) for memory and/or processing capabilities. For example, the wireless device may lack sufficient resources to store a rolling transmit power history having a series of transmit powers (e.g., 200 or more) over a time-averaging time window. The wireless device may lack the processing resources (e.g., latency, clock rate, throughput, channel capacity, processing time, etc.) to perform a running time-averaging calculation within a particular processing time (e.g., 500 ms). In some cases, the wireless device may be an IoT device, a low-cost cellular phone, or a device having a budget or low-cost modem, such that the filter-based time-averaging evaluation described herein facilitates enhanced wireless communication performance for such device(s).

Aspects of the present disclosure may be applied to any of various wireless communication devices (wireless devices) that may emit RF signals causing exposure to human tissue, such as a base station and/or a CPE, performing the RF exposure compliance described herein.

### Example Communications Device

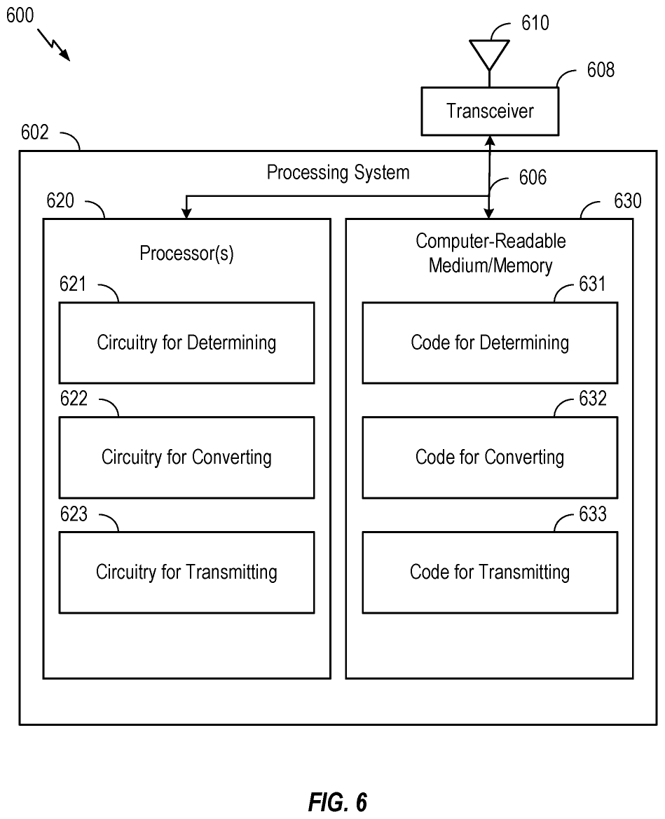

FIG. 6 depicts aspects of an example communications device 600. In some aspects, communications device 600 is a wireless communication device, such as the first wireless device 102 described above with respect to FIGS. 1 and 2.

The communications device 600 includes a processing system 602 coupled to a transceiver 608 (e.g., a transmitter and/or a receiver). The transceiver 608 is configured to transmit and receive signals for the communications device 600 via an antenna 610, such as the various signals as described herein. The processing system 602 may be configured to perform processing functions for the communications device 600, including processing signals received and/or to be transmitted by the communications device 600.

The processing system 602 includes one or more processors 620. In various aspects, the one or more processors 620 may be representative of any of the processor 210 and/or the modem 212, as described with respect to FIG. 2. The one or more processors 620 are coupled to a computer-readable medium/memory 630 via a bus 606. In certain aspects, the computer-readable medium/memory 630 is configured to store instructions (e.g., computer-executable code) that when executed by the one or more processors 620, cause the one or more processors 620 to perform the operations 500 described with respect to FIG. 5, or any aspect related to the operations described herein. Note that reference to a processor performing a function of communications device 600 may include one or more processors performing that function of communications device 600. Reference to one or more processors performing multiple functions may include any one of the one or more processors performing any one of the multiple functions.

In the depicted example, computer-readable medium/memory 630 stores code (e.g., executable instructions) for determining 631, code for converting 632, code for transmitting 633, or any combination thereof. Processing of the code 631-633 may cause the communications device 600 to perform the operations 500 described with respect to FIG. 5, or any aspect related to operations described herein.

The one or more processors 620 include circuitry configured to implement (e.g., execute) the code stored in the computer-readable medium/memory 630, including circuitry for determining 621, circuitry for converting 622, circuitry for transmitting 623, or any combination thereof. Processing with circuitry 621-623 may cause the communications device 600 to perform the operations 500 described with respect to FIG. 5, or any aspect related to operations described herein.

Various components of the communications device 600 may provide means for performing the operations 500 described with respect to FIG. 5, or any aspect related to operations described herein. For example, means for transmitting, sending or outputting for transmission may include the TX path 214 and/or antenna(s) 218 of the first wireless device 102 illustrated in FIG. 2 and/or transceiver 608 and antenna 610 of the communications device 600 in FIG. 6. Means for receiving or obtaining may include the RX path 216 and/or antenna(s) 218 of the first wireless device illustrated in FIG. 2 and/or transceiver 608 and antenna 610 of the communications device 600 in FIG. 6. Means for determining and/or means for converting may include one or more processors, such as the processor 210 and/or modem 212 depicted in FIG. 2 and/or the processor(s) 620 in FIG. 6.

### Example Aspects

Implementation examples are described in the following numbered clauses:

Clause 1: A method of wireless communication by a wireless device, comprising: determining an effective time-averaged transmit power associated with one or more past transmissions using a filter; and transmitting a signal in a time interval at a transmit power determined based at least in part on the effective time-averaged transmit power in compliance with a radio frequency (RF) exposure limit.

Clause 2: The method of Clause 1, wherein the filter is based on an n^{th} order infinite impulse response filter, where n>0.

Clause 3: The method of Clause 1, wherein the filter is based on an integrating filter.

Clause 4: The method of Clause 1, wherein the filter includes a recursive averaging filter.

Clause 5: The method according to any of Clauses 1-4, wherein the effective time-averaged transmit power is determined based at least in part on a time-averaged transmit power for one or more past time intervals, a scaling factor, and a filter value associated with one or more past time intervals.

Clause 6: The method according to any of Clauses 1-5, wherein determining the effective time-averaged transmit power further comprises: determining a first term as a product of the scaling factor and a largest value among a default value and a difference between the time-averaged transmit power and a reserve level; determining a second term as a product of the filter value and a difference between one and the scaling factor; and determining a sum of the first term and the second term as the effective time-averaged transmit power.

Clause 7: The method according to any of Clauses 1-6, further comprising: determining a normalized transmit power budget based at least in part on a reserve level and the effective time-averaged transmit power; and converting the normalized transmit power budget to a maximum allowed transmit power for the time interval, wherein the transmit power is less than or equal to the maximum allowed transmit power.

Clause 8: The method of Clause 7, wherein the normalized transmit power budget is converted to the maximum allowed transmit power using a duty cycle associated with one or more transmissions.

Clause 9: The method according to any of Clauses 1-4, further comprising determining no past transmissions have occurred in a time-averaging time window for RF exposure compliance, wherein determining the effective time-averaged transmit power comprises setting the effective time-averaged transmit power to a particular value in response to determining no past transmissions have occurred in the time-averaging time window.

Clause 10: The method according to any of Clauses 1-4, further comprising determining no past transmissions have occurred in one or more past time intervals, wherein the effective time-averaged transmit power is determined using a default transmit power for the one or more past time intervals in response to determining no past transmissions have occurred in the one or more past time intervals.

Clause 11: The method according to any of Clauses 1-10, wherein the wireless device lacks sufficient resources to store a rolling transmit power history having a series of transmit powers over a time-averaging time window.

Clause 12: The method according to any of Clauses 1-11, wherein the wireless device is an Internet of things (IoT) device.

Clause 13: An apparatus for wireless communication, comprising: one or more memories collectively storing computer-executable instructions; one or more processors coupled to the one or more memories, the one or more processors being collectively configured to execute the computer-executable instructions to cause the apparatus to perform an operation comprising: determining an effective time-averaged transmit power associated with one or more past transmissions using a filter; determining a transmit power based at least in part on the effective time-averaged transmit power in compliance with a radio frequency (RF) exposure limit; and transmitting a signal in a time interval at the determined transmit power.

Clause 14: The apparatus of Clause 13, wherein the filter is based on an n^{th} order infinite impulse response filter, where n>0.

Clause 15: The apparatus of Clause 13, wherein the filter is based on an integrating filter.

Clause 16: The apparatus of Clause 13, wherein the filter includes a recursive averaging filter.

Clause 17: The apparatus according to any of Clauses 13-16, wherein the effective time-averaged transmit power is determined based at least in part on a time-averaged transmit power for one or more past time intervals, a scaling factor, and a filter value associated with one or more past time intervals.

Clause 18: The apparatus according to any of Clauses 13-17, wherein determining the effective time-averaged transmit power comprises: determining a first term as a product of the scaling factor and a largest value among a default value and a difference between the time-averaged transmit power and a reserve level; determining a second term as a product of the filter value and a difference between one and the scaling factor; and determining a sum of the first term and the second term as the effective time-averaged transmit power.

Clause 19: The apparatus according to any of Clauses 13-18, wherein the operation further comprises: determining a normalized transmit power budget based at least in part on a reserve level and the effective time-averaged transmit power; and converting the normalized transmit power budget to a maximum allowed transmit power for the time interval, wherein the transmit power is less than or equal to the maximum allowed transmit power.

Clause 20: The apparatus of Clause 19, wherein the normalized transmit power budget is converted to the maximum allowed transmit power using a duty cycle associated with one or more transmissions.

Clause 21: The apparatus according to any of Clauses 13-16, wherein: the operation further comprises determining no past transmissions have occurred in a time-averaging time window for RF exposure compliance; and determining the effective time-averaged transmit power comprises setting the effective time-averaged transmit power to a particular value in response to determining no past transmissions have occurred in the time-averaging time window.

Clause 22: The apparatus according to any of Clauses 13-16, wherein: the operation further comprises determining no past transmissions have occurred in one or more past time intervals; and determining the effective time-averaged transmit power comprises using a default transmit power for the one or more past time intervals in response to determining no past transmissions have occurred in the one or more past time intervals.

Clause 23: The apparatus according to any of Clauses 13-22, wherein the apparatus lacks sufficient resources to store a rolling transmit power history having a series of transmit powers over a time-averaging time window.

Clause 24: The apparatus according to any of Clauses 13-23, wherein the apparatus is an Internet of things (IoT) device.

Clause 25: An apparatus, comprising: one or more memories collectively storing computer-executable instructions, and one or more processors coupled to the one or more memories, the one or more processors being collectively configured to implement a filter and to execute the computer-executable instructions to cause the apparatus to perform a method in accordance with any of Clauses 1-12.

Clause 26: An apparatus for wireless communication, comprising: means for performing a method in accordance with any of Clauses 1-12.

Clause 27: A non-transitory computer-readable medium comprising computer-executable instructions that, when collectively executed by one or more processors of a processing system, cause the processing system to perform a method in accordance with any of Clauses 1-12.

Clause 28: A computer program product embodied on a computer-readable storage medium comprising code for performing a method in accordance with any of Clauses 1-12.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a microcontroller, a microprocessor, a general-purpose processor, a digital signal processor (DSP), a neural network processor, an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor,” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory,” or “one or more memories” generally refers to a single memory configured to store data and/or instructions or multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, identifying, mapping, applying, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” The use of a definite article (e.g., “the” or “said”) before an element is not intended to impart a singular meaning (e.g., “one and only one”) on an otherwise plural meaning (e.g., “one or more”) associated with the element unless specifically so stated. Unless specifically stated otherwise, the term “some” refers to one or more. No claim element is to be construed under the provisions of 35 U.S.C. § 112 (f) unless the element is expressly recited using the phrase “means for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method of wireless communication by a wireless device, comprising:
determining an effective time-averaged transmit power associated with one or more past transmissions using a filter; and
transmitting a signal in a time interval at a transmit power determined based at least in part on the effective time-averaged transmit power in compliance with a radio frequency (RF) exposure limit.

2. The method of claim 1, wherein the filter is based on an n^{th} order infinite impulse response filter, where n>0.

3. The method of claim 1, wherein the filter is based on an integrating filter.

4. The method of claim 1, wherein the filter includes a recursive averaging filter.

5. The method of claim 1, wherein the effective time-averaged transmit power is determined based at least in part on a time-averaged transmit power for one or more past time intervals, a scaling factor, and a filter value associated with one or more past time intervals.

6. The method of claim 5, wherein determining the effective time-averaged transmit power further comprises:
determining a first term as a product of the scaling factor and a largest value among a default value and a difference between the time-averaged transmit power and a reserve level;
determining a second term as a product of the filter value and a difference between one and the scaling factor; and
determining a sum of the first term and the second term as the effective time-averaged transmit power.

7. The method of claim 5, further comprising:
determining a normalized transmit power budget based at least in part on a reserve level and the effective time-averaged transmit power; and
converting the normalized transmit power budget to a maximum allowed transmit power for the time interval, wherein the transmit power is less than or equal to the maximum allowed transmit power.

8. The method of claim 7, wherein the normalized transmit power budget is converted to the maximum allowed transmit power using a duty cycle associated with one or more transmissions.

9. The method of claim 1, further comprising determining no past transmissions have occurred in a time-averaging time window for RF exposure compliance, wherein determining the effective time-averaged transmit power comprises setting the effective time-averaged transmit power to a particular value in response to determining no past transmissions have occurred in the time-averaging time window.

10. The method of claim 1, further comprising determining no past transmissions have occurred in one or more past time intervals, wherein the effective time-averaged transmit power is determined using a default transmit power for the one or more past time intervals in response to determining no past transmissions have occurred in the one or more past time intervals.

11. The method of claim 1, wherein the wireless device lacks sufficient resources to store a rolling transmit power history having a series of transmit powers over a time-averaging time window.

12. The method of claim 1, wherein the wireless device is an Internet of things (IoT) device.

13. An apparatus for wireless communication, comprising:
one or more memories collectively storing computer-executable instructions;
one or more processors coupled to the one or more memories, the one or more processors being collectively configured to implement a filter and to execute the computer-executable instructions to cause the apparatus to perform an operation comprising:
determining an effective time-averaged transmit power associated with one or more past transmissions using the filter;
determining a transmit power based at least in part on the effective time-averaged transmit power in compliance with a radio frequency (RF) exposure limit; and
transmitting a signal in a time interval at the determined transmit power.

14. The apparatus of claim 13, wherein the filter is based on an n^{th} order infinite impulse response filter, where n>0.

15. The apparatus of claim 13, wherein the filter is based on an integrating filter.

16. The apparatus of claim 13, wherein the filter includes a recursive averaging filter.

17. The apparatus of claim 13, wherein the effective time-averaged transmit power is determined based at least in part on a time-averaged transmit power for one or more past time intervals, a scaling factor, and a filter value associated with one or more past time intervals.

18. The apparatus of claim 17, wherein determining the effective time-averaged transmit power comprises:
determining a first term as a product of the scaling factor and a largest value among a default value and a difference between the time-averaged transmit power and a reserve level;
determining a second term as a product of the filter value and a difference between one and the scaling factor; and
determining a sum of the first term and the second term as the effective time-averaged transmit power.

19. The apparatus of claim 17, wherein the operation further comprises:
determining a normalized transmit power budget based at least in part on a reserve level and the effective time-averaged transmit power; and
converting the normalized transmit power budget to a maximum allowed transmit power for the time interval, wherein the transmit power is less than or equal to the maximum allowed transmit power.

20. The apparatus of claim 19, wherein the normalized transmit power budget is converted to the maximum allowed transmit power using a duty cycle associated with one or more transmissions.

21. The apparatus of claim 13, wherein:
the operation further comprises determining no past transmissions have occurred in a time-averaging time window for RF exposure compliance; and
determining the effective time-averaged transmit power comprises setting the effective time-averaged transmit power to a particular value in response to determining no past transmissions have occurred in the time-averaging time window.

22. The apparatus of claim 13, wherein:
the operation further comprises determining no past transmissions have occurred in one or more past time intervals; and
determining the effective time-averaged transmit power comprises using a default transmit power for the one or more past time intervals in response to determining no past transmissions have occurred in the one or more past time intervals.

23. The apparatus of claim 13, wherein the apparatus lacks sufficient resources to store a rolling transmit power history having a series of transmit powers over a time-averaging time window.

24. The apparatus of claim 13, wherein the apparatus is an Internet of things (IoT) device.

25. A non-transitory computer-readable medium storing code that, when collectively executed by one or more processors of an apparatus, cause the apparatus to perform a method, the method comprising:
determining an effective time-averaged transmit power associated with one or more past transmissions using a filter; and
transmitting a signal in a time interval at a transmit power determined based at least in part on the effective time-averaged transmit power in compliance with a radio frequency (RF) exposure limit.

26. The non-transitory computer-readable medium of claim 25, wherein the filter is based on an n^{th} order infinite impulse response filter, where n>0.

27. The non-transitory computer-readable medium of claim 25, wherein the effective time-averaged transmit power is determined based at least in part on a time-averaged transmit power for one or more past time intervals, a scaling factor, and a filter value associated with one or more past time intervals.

28. The non-transitory computer-readable medium of claim 27, wherein determining the effective time-averaged transmit power further comprises:
determining a first term as a product of the scaling factor and a largest value among a default value and a difference between the time-averaged transmit power and a reserve level;
determining a second term as a product of the filter value and a difference between one and the scaling factor; and
determining a sum of the first term and the second term as the effective time-averaged transmit power.

29. The non-transitory computer-readable medium of claim 27, further comprising:
determining a normalized transmit power budget based at least in part on a reserve level and the effective time-averaged transmit power; and
converting the normalized transmit power budget to a maximum allowed transmit power for the time interval, wherein the transmit power is less than or equal to the maximum allowed transmit power.

30. The non-transitory computer-readable medium of claim 29, wherein the normalized transmit power budget is converted to the maximum allowed transmit power using a duty cycle associated with one or more transmissions.
